(19) United States
(12) Patent Application Publication
(10) Pub. No.: US 2016/0073620 A1
(43) Pub. Date: Mar. 17, 2016

(54) Bottom bouncer with swiveling section

(71) Applicant: Yvan Belanger, Chapais (CA)

(72) Inventor: Yvan Belanger, Chapais (CA)

(21) Appl. No.: 14/846,734

(22) Filed: Sep. 5, 2015

(30) Foreign Application Priority Data
Sep. 14, 2014 (GB) 1416207.7

(51) Int. Cl. A01K 91/14; A01K 91/047; A01K 91/04; A01K 95/00

(52) U.S. Cl. CPC A01K 91/14; A01K 95/00; A01K 91/047; A01K 91/04

(57) ABSTRACT

A bottom bouncer with swiveling section a lure arm member pivotally attached to a weighted arm member has an elongated rod having a weight affixed to it and a tip extending longitudinally therefrom to form one end. The lure arm member has one of its end terminated by an end loop to which is clipped an interlock snap swivel. The interlock snap swivel is used for attaching a lure line. The weighted arm member has an angled bend which is comprised of a bushing, and a pair of balls, wherein one of the ball is located on one side of a ring and the other ball is positioned on the opposite side of the ring. The ring is made from a loop portion extending integrally from the lure arm member. The bushing is frictionally connected to the weighted arm member so as to squeeze the balls between the bushing and a grommet, and the ring is rotationally connected to the weighted arm member passing therethrough such that the lure arm member can pivot around an axis formed by the weighted arm member.

### FIELD OF THE INVENTION

The present invention relates generally to sport fishing equipment but more particularly to a bottom bouncer with swiveling section.

### BACKGROUND OF THE INVENTION

Fishing as a sport is popular and fishermen are always on the lookout for better methods, equipment and ways to catch fish. There exist different methods for catching different fish, one of which is trolling by which fishermen drag a lure or bait from a moving boat to catch species such as larger Walleye which feed near the bottom of a lake or river. There currently exists a bottom bouncer mechanism which facilitates this trolling method of fishing, however it is subject to certain inefficiencies such as the line getting tangled around the main stem. There hence exists a need for an improved bottom bouncer mechanism for trolling.

### SUMMARY OF THE INVENTION

In view of the foregoing disadvantages inherent in the known devices now present in the prior art, the present invention, which will be described subsequently in greater detail, is to provide objects and advantages which are:

To provide for an improved bottom bouncer consisting of two pieces which allow pivotal movement for the lure arm thereby reducing chances of tangling the line.

In order to do so, the invention comprises a lure arm member pivotally attached to a weighted arm member.

The weighted arm member is an elongated rod having a weight affixed to it and a tip extending longitudinally therefrom to form one end.

The lure arm member has one of its end terminated by an end loop to which is clipped an interlock snap swivel.

The interlock snap swivel is used for attaching a lure line.

The weighted arm member has an angled bend which is comprised of a bushing, and a pair of balls, wherein one of the ball is located on one side of a ring and the other ball is positioned on the opposite side of the ring.

The ring is made from a loop portion extending integrally from the lure arm member.

The bushing is frictionally connected to the weighted arm member so as to squeeze the balls between the bushing and a grommet, and the ring is rotationally connected to the weighted arm member passing therethrough such that the lure arm member can pivot around an axis formed by the weighted arm member.

The tip portion from the weighted arm member ends with a grommet onto which a fishing line is attached.

The bottom bouncer with swiveling section in used in combination with a fishing line and a lure line.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiment of the invention.

### BRIEF DESCRIPTION OF THE DRAWINGS

FIG. 1 Side view of the invention.

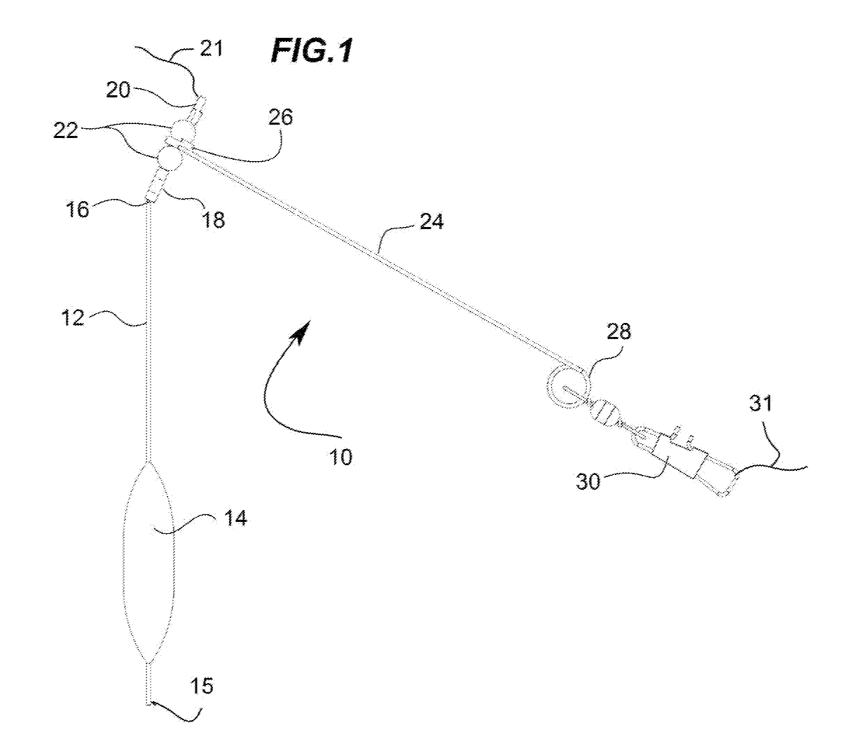

FIG. 2 Isometric view of the invention.

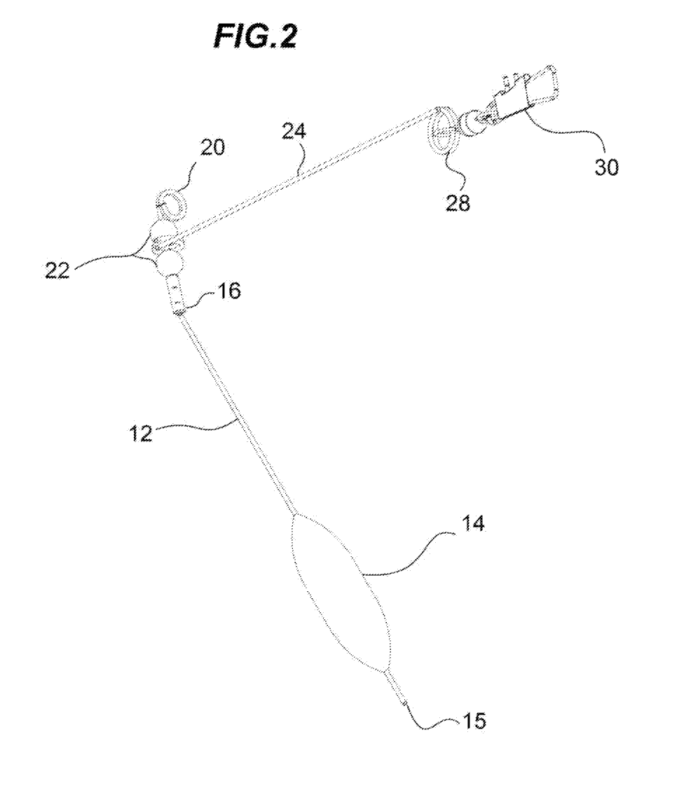

### DETAILED DESCRIPTION

A bottom bouncer with swiveling section (10) comprising a rod like weighted arm member (12) further comprising a fixed weight (14), an angled bend (16) which is comprised of a bushing (18), and a pair of balls (22), wherein one is located on one side of a ring (26) and the other is positioned on the opposite side of the ring (26). The ring (26) is made from a loop portion extending integrally from a lure arm member (24).

The bushing (18) is frictionally connected to the weighted arm member (12) so as to squeeze the balls between it and a grommet (20). The ring (26) is rotationally connected to the weighted arm member (12) passing therethrough such that the lure arm member (24) can pivot around an axis formed by the weighted arm member (12).

One end of the weighted arm member (12) ends with the grommet (20) onto which a fishing line (21) is attached, while the opposite end extending from the weight (14) ends with a tip (15) touching the bottom of a body of water.

The opposite end of the lure arm member (24) has an end loop (28) to which is clipped an interlock snap swivel (30). The interlock snap swivel (30) is where a lure line (31) is affixed.

Typically, a bottom bouncer (10) is used when trolling from a boat and the tip of the weighted arm member (12) points downwardly and touches the bottom of a given water body and keeps the lure arm member (24), and thus the fishing line (21) some distance above the bottom of the water body, where the fish that are targeted are. Because there is a lure line (31) and a fishing line (21) in close proximity, there is a risk of entanglement when using a bottom bouncer of the prior art where the weighted line member (12) and the lure line member (24) are not pivotally connected.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A bottom bouncer with swiveling section comprising a lure arm member pivotally attached to a weighted arm member.

2. A bottom bouncer with swiveling section as in claim 1 wherein said weighted arm member is an elongated rod having a weight affixed to it and a tip extending longitudinally therefrom to form one end.

3. A bottom bouncer with swiveling section as in claim 1 wherein said lure arm member has one of its end terminated by an end loop to which is clipped an interlock snap swivel.

4. A bottom bouncer with swiveling section as in claim 3 wherein said interlock snap swivel is used for attaching a lure line.

5. A bottom bouncer with swiveling section as in claim 1 wherein the weighted arm member has an angled bend which is comprised of a bushing, and a pair of balls, wherein one said ball is located on one side of a ring and the other said ball is positioned on the opposite side of said ring.

6. A bottom bouncer with swiveling section as in claim 5 wherein said ring is made from a loop portion extending integrally from said lure arm member.

7. A bottom bouncer with swiveling section as in claim 5 wherein said bushing is frictionally connected to said weighted arm member so as to squeeze said balls between said bushing and a grommet, and said ring is rotationally connected to said weighted arm member passing therethrough such that said lure arm member can pivot around an axis formed by said weighted arm member.

8. A bottom bouncer with swiveling section as in claim 2 wherein said tip portion from said weighted arm member ends with a grommet onto which a fishing line is attached.

9. A bottom bouncer with swiveling section in combination with a fishing line and a lure line comprising a lure arm member pivotally attached to a weighted arm member.

10. A bottom bouncer with swiveling section in combination with a fishing line and a lure line as in claim 9 wherein said weighted arm member is an elongated rod having a weight affixed to it and a tip extending longitudinally therefrom to form one end.

11. A bottom bouncer with swiveling section in combination with a fishing line and a lure line as in claim 9 wherein said lure arm member has one of its end terminated by an end loop to which is clipped an interlock snap swivel.

12. A bottom bouncer with swiveling section in combination with a fishing line and a lure line as in claim 11 wherein said interlock snap swivel is used for attaching a lure line.

13. A bottom bouncer with swiveling section in combination with a fishing line and a lure line as in claim 9 wherein the weighted arm member has an angled bend which is comprised of a bushing, and a pair of balls, wherein one said ball is located on one side of a ring and the other said ball is positioned on the opposite side of said ring.

14. A bottom bouncer with swiveling section in combination with a fishing line and a lure line as in claim 13 wherein said ring is made from a loop portion extending integrally from said lure arm member.

15. A bottom bouncer with swiveling section in combination with a fishing line and a lure line as in claim 13 wherein said bushing is frictionally connected to said ring while being rotationally connected to said weighted arm member passing therethrough such that said lure arm member can pivot around an axis formed by said weighted arm member.

16. A bottom bouncer with swiveling section in combination with a fishing line and a lure line as in claim 10 wherein said tip portion from said weighted arm member ends with a grommet onto which a fishing line is attached.
